(19) United States
(12) Patent Application Publication
(10) Pub. No.: US 2007/0231428 A1
(43) Pub. Date: Oct. 4, 2007

(54) Tea-flavored beer

(76) Inventors: Normand Anthony Mensour, Ancaster (CA); Ann Paula Cristiane Viaene, Leuven (BE)

Correspondence Address: James W. Kerr, 303 Richmond Street, London, ON, N6B 2H8, CA

(21) Appl. No.: 11/393,745

(22) Filed: Mar. 31, 2006

(51) Int. Cl. C12C 11/00

(52) U.S. Cl. 426/16

(57) ABSTRACT

The present invention relates to the preparation of a white tea flavored beer notwithstanding the difficulty associated with the production of a well balanced tea flavored beer due that is associated with the compound effects of tea astringency and the bitterness and harshness of the beer. Nevertheless savory and floral qualities of white tea flavor provide notes of roasted nuts and dried flowers in a well balanced beverage that successfully combined a white tea flavor with beer while maintaining the characteristic flavor profile of the white tea.

### FIELD OF THE INVENTION

The present invention relates to tea-flavored beers, and in particular beers having Camellia sp (especially C. sinensis) like flavors. More specifically, the present invention relates to beer including “white” tea flavors associated with C. sinensis; and, especially to beers containing white tea flavor extracts from C. sinensis.

### BACKGROUND OF THE INVENTION

Beer, in general is produced from grains/cereal starches that have been broken down to produce a wort containing fermentable sugars. The fermentable sugars are then consumed by brewers yeast in the production of ethanol, and the final product is variously filtered, clarified and packaged for distribution and sale.

Flavored beer-based products have long been popular in some, albeit limited sized markets. Fruit-flavored Lambic beers are a traditional example, and more recently the market has seen a wide range of citrus-flavored malt-based beverages.

There is a need in the beer market for modern sophisticated beverage offerings that do not depend on overly sweet/sour masking or other approaches to obscuring or avoiding at least some of beer's basic traditional malt flavour profile.

Tea is a very popular beverage. Moreover, attempts have been made in the past, to produce tea flavored beers.

Combinations of tea and beer have been proposed. JP58179476, for example discloses a color-stable fermented malt beverage including a herb extract such as green or black teas that result in improved health. JP 7289230 also discloses the addition of tea extracts to beer to improve health.

Health benefits aside, however, there is an inherent incompatibility in the flavour of the two products—which in turn poses a huge barrier to commercial acceptance of beer tea mixtures. Black teas for example, have a lingering astringency and green teas are often associated with grassy flavors. Both are considered to be significant flavour defects in beer.

For example, flavor issues are the focus of EP 0 784 671 B1. This patent discloses a low alcohol, (2.5 to 2.8% v/v) ultra-filtered neutral malt base, that can be flavored with tea, provided the resultant product is amongst other things, free of tartaric acid (to minimize lingering dry/sour tastes).

Lindemans Tea Beer is a Lambic beer matured on tea leaves, resulting in a tea-flavored beer that is best drunk ice-cold. Lambic beer has prominent sour flavour notes of its own and is not faced with the problems dealt with in the last above mentioned EP patent. Indeed, this tea-flavored Lambic beer is often served with lemon. Moreover, the very cold serving temperature, helps to negate some of the flavour imbalances that the beer and tea combination may otherwise engender.

JP 10179113 discloses the addition to black tea to the malt mash so that the turbidity that the mixture produces is removed during subsequent wort/beer production steps. While it is possible that this addition of the tea so early in the brewing process may reduce its adverse flavour impact in the final beverage combination, but it is also reasonable to presume that the turbidity problem that the patent addresses is a collateral manifestation of the removal of tea polyphenols and hence results in an associated reduction of any the potential health benefits.

Tea is also a source of caffeine. While combinations of caffeine and beer have become popular, producers of such products have tended to rely on guarana containing extracts—again, presumably because of flavour issues associated with tea are not inherently problematic when employing guarana as a source of caffeine in beer. Examples include:
AT406872B—A novel brewed beverage whose characteristic property is that it has been obtained with the addition of guarana is described. The guarana can be added before, during or after the fermentation, and it is preferably included in the brew, in the production of the beer.
FR2659980—The invention relates to a drink intended for human beings whose composition is a mixture of the following ingredients; Beer (water, malt, hops), carbonated water, flavored plant extracts, citric acid, sugar, soda water, caffeine, vanilla, coloring. The process of manufacture is the normal process for the manufacture of beer, subsequently mixed with the abovementioned ingredients. This product would be contained in bottles or boxes made from any material and of any shape, for short or long preservation. This product would be consumed cold.
EP0252063—The beverage contains carbonic acid and, as main ingredient, a fermentation product based on hops and malt, in particular beer, and additives which have a stimulant effect on the human body, such as caffeine and the like. The beverage can, where appropriate, also contain foodstuff colors for the purpose of coloring the beverage to a required shade.
W09732006—A method of improving the bitterness and astringency properties of a brewed malt beverage is disclosed. The method involves adding guarana solids prior to or following fermentation which results in a brewed malt beverage having improved organoleptic properties, including aroma strength, astringency, bitterness, hop character, fruity character, and ester character.
DE19611827—Carbonated drinks, for refreshment or for use as mixers, containing as essential ingredients taurine, caffeine or guarana and carbonic acid. The drink optionally also contains alcohol in an amount of less than 15 vol. %.
JP59227277—A drink containing an extract of a guarana, having good palatability of improved taste, by immersing seed of a guarana in a drinkable alcohol, preparing a drink containing the extracted solution of it as one component.

These patents demonstrate the potential market for mildly stimulating caffeine containing products, such as beer.

More generally speaking, while there is undoubtedly a considerable overlap between tea and beer drinking markets, it might be generally assumed that the consumption of beer forecloses to at least some degree on the alternative consumption of tea, and vice versa. It would be desirable, however, to secure the advantages of both, without having to give up the enjoyment of one or the other.

In addition, there remains a need in the art to secure as much/many of the potential health benefits as may be associated with tea as an additive, without compromising the flavour of any products to which the tea may be added. This is particularly the case for beer, where typical tea flavors are not only manifest strongly, but also contrary to accepted organoleptic norms of desirable beer flavors.

Unfortunately, as already mentioned herein, green tea flavor is associated with a pronounced grassy flavor associated with defects in hop flavoring of the beer. Black tea flavor is strongly astringent—and astringency is another flavor defect in beer products. On its face, there is a seemingly inherent incompatibility with beer and tea flavors—and the above reference prior art attempts to deal in various ways with that incompatibility would seem to support this view.

### SUMMARY OF THE INVENTION

In accordance with the present invention, it has now been found that white tea flavors are not incompatible with beer flavors. This applies to flavors that are compounded by flavor houses, as well as to flavor and flavored extracts from white tea plants per se.

Botanically speaking tea plants as referred to herein is a general reference to what under contemporary taxonomy is classed under the so-named Camellia genus. For the purposes of the present invention, to be treated as synonymous with the genus Thea.

As a genus, the plant follows a cross-pollination reproductive strategy and hence its speciation is highly heterogeneous, encompassing many varieties and sub-varieties, (some of these having been from time to time, afforded species status in their own right).

While the genus Camellia includes a large number of species, C. sinensis is of the most commercial significance. Presently that species includes at least three distinct taxa, denominated respectively as: China; Assam; and, Cambod. For the purposes of the present invention, the relevance of these distinctions are not of primary importance. However, “tea” in the sense it is used here, excludes so-called “herbal teas” derived from other botanical sources.

In any case, commercial agronomic practices maintain these evergreen shrubs of the genus Camellia in a continuous vegetative growth state as a short, pruned bush. The plant is harvested in due course by removing growth from the upper stem portion of the bush—usually the two or three uppermost shoots and a bud (sometimes collectively referred to as the flush), from the bushes actively growing plant. This new growth develops from along the top and sides of the bushes, being produced by the underlying, so-called, “maintenance” foliage.

The maturity of the harvest, and the subsequent processing is what distinguishes the type of tea that is produced—and determines its suitability in combination with beer. White tea is distinguished from other teas on this basis.

Black and green teas are generally well known. Black tea has been fully “fermented” during processing, and green tea while not actively “fermented” during processing still typically starts out with a harvest of mature tea leaves followed by post-harvest processing that is limited to some withering followed by steaming or pan-frying—e.g. the Sen-cha process or the Kamairi-cha process. Oolong teas are known as semi-fermented teas, and their processing generally falls somewhere in the middle between that associated with green and black teas, respectively.

Fresh tea leaves are rich in flavonoids known as catechins. Tea leaves also contain polyphenol oxidase enzymes in separate compartments from catechins—but processing to various degrees, (breaking of the leaves or their “rolling”) releases the indigenous polyphenol oxidase which in turn causes the native catechins to polymerize (forming dimers and polymers) into theaflavins and thearubigins. Subsequent steaming or firing of the tea leaves inactivates polyphenol oxidase and arrests the fermentation process.

Although there are thousands of tea varieties, teas may be divided into groups, based on the amount of fermentation they undergo during processing. The term fermentation when applied to tea is something of a misnomer, as the term actually refers to how much a tea is allowed/encouraged to undergo enzymatic oxidation by allowing the freshly picked tea leaves to dry. This enzymatic oxidation process may be stopped by either pan frying or steaming the leaves before they are completely dried out. One method of classifying teas is based on the degree of fermentation: a) Non-fermented and Lightly fermented, b) Semi-fermented, c) Fully-fermented.

Non-fermented and Lightly fermented: These teas retain a preponderance of their unprocessed flavor. At one end of the spectrum, white teas (immature leaves) are permitted to undergo at most only the very light collateral fermentation that occurs during the withering process. Green teas fall towards the lightly fermented extreme of this category. Most processing of green teas arrest the fermentation process of the mature leaf harvest, through pan frying—although other processes rely on steaming.

Semi-fermented: Teas which are allowed to undergo 10% to 80% fermentation fall into the broad category of semi-fermented teas. Tea brewed from semi-fermented tea leaves have a slight yellow to brown hue and possess a subtle fragrant aroma. These teas can be further classified into three categories based on their levels of fermentation:
Light (10%-20%);
Medium (20%-50%); and,
Heavy (50%-80%).

Fully-fermented: Black teas are fully fermented. Tea from black tea leaves have a dark red hue and a sweet aroma of malt sugar.

White tea, technically speaking, is unfermented, and in any case, even less so than is typical of green tea. Moreover the white leaves are immature when harvested. White tea is generally less well known than the other commercial teas, even though all typically come from the Camellia sinensis plant. However, in the case of white tea, the leaves are picked and harvested before the leaves open fully, and while the buds are still covered by fine white hair. White tea is scarce and substantially more expensive.

While white tea is similar to green tea in the sense that they are the least processed of the C. sinensis teas, but they differ substantially with respect to taste. Most green teas have a distinctive ‘grassy’ taste to them, but white tea does not. Instead, white tea flavour is described as light, and sweet—particularly when steeped below the boiling point of water.

Leaves destined for the production of white teas are plucked from the downy premature leaves of the tea plant. As already mentioned, they further differ from green teas, inter alia, in that they are not usually pan-fired or steamed but rather allowed to dry naturally. White teas are generally higher in antioxidants than green teas. In addition to the distinctive taste of white teas, they are healthier—having high concentrations of tea antioxidants.

White teas are produced mostly in China and Japan, but the Darjeeling region of India also produces some fine white teas.

White tea flavors are available from commercial flavor houses, and white tea flavor extracts are well within the ordinary contemporary skills of those trained in the beverage and flavor arts.

Broadly speaking, the present invention relates to white tea flavored beers.

In one embodiment, that beer comprises one or more of the group consisting of: white tea flavor; and/or white tea flavor extract, and preferably comprises a white tea flavor extract. That white tea flavor extract preferably includes monomeric catechins—and more particularly, monomeric catechins including one or more of the group consisting of: epicatechin, epigallocatechin, epicatechin gallate, and/or epigallocatechin gallate.

In another aspect of the foregoing, that extract further includes one or more of the group consisting of: fluoride, caffeine, and/or flavonols—and especially, flavonols that are selected from the group consisting of kaempferol, quercetin, and/or myricitin.

In accordance with a preferred aspect of the invention, the extract is added following beer filtration.

### DETAILED DESCRIPTION OF THE INVENTION

Tea in general contains a number of bioactive chemicals, including caffeine and fluoride—however, the particular expectations of health benefits are associated with a class of compounds in tea known as flavonoids and especially, catechins. White tea has the highest post-processing retention of catechins, and although green teas are also rich in catechins, they tend to have a different catechin profile than white tea.

Flavanols are the most abundant class of the dietary flavonoids in tea. Flavanol monomers are also known as catechins and the principle species found in tea are epicatechin, epigallocatechin, epicatechin gallate, and epigallocatechin gallate. Tea is also a good source of another class of flavonoids, called flavonols. Flavonols found in tea include kaempferol, quercetin, and myricitin. The flavonol content of tea is less affected by processing than is the flavanols content, and flavonols are present in comparable quantities in fermented and unfermented teas. Unlike flavanols, flavonols are usually present in tea as glycosides (bound to a sugar molecule).

All teas contain caffeine, unless they are deliberately decaffeinated during processing. The amount of caffeine varies widely between types of teas, but buds and immature tea leaves have been found to contain higher levels of caffeine than older leaves—which in turn suggests that the caffeine content of white teas may tend to be slightly higher than that of green teas.

Tea plants accumulate fluoride in their leaves, and in general, older tea leaves tend to contain more fluoride than younger leaves. On the other hand, supplemental sources of fluoride are generally widely available, so the relatively lower levels associated with younger leaves is an overall advantage, (based on the reasoning that excessive levels of dietary fluoride are undesirable).

In general, the amount of these materials that are added to beer in accordance with the present invention will only be supplemental to an overall daily intake. Nevertheless, the amount of catechins added in this way are supplemental to the catechins that are already indigenous to beers (polyphenols), and adds to the opportunities for such materials to be ingested over the course of a day. Proportionate to other teas, white tea extracts contain several times greater levels of catechins—and so can provide a greater level of supplementation. Given that plasma half lives of catechins, the more often a consumer is exposed to a dietary source, the greater the bioavailable exposure. The flavor compatibility of beer and white tea, make this form of supplementation from monomeric catechin containing extracts much more palatable.

### Preferred Embodiments

Note that monomeric catechins have little effect on beer haze formation (unlike condensed polyphenols). However, post-filtration addition of white tea flavour extracts is preferred (beer filtration is associated with a significant decrease in catechin levels).

In preparing tea extracts useful in the present invention, exemplary white tea extracts should be prepared in water at a temperature as indicated below, or lower. Steep times in the range shown are also preferred.

| Tea | Water Temperature | Steep Time |
|---|---|---|
| Green Tea | 160 degrees F. | 1-3 minutes |
| White Tea | 180 degrees F. | 4-8 minutes |

The addition of complementary amounts of green tea extract can be employed to provide tannins with related tea/tannin mouth-feel and green tea polyphenol content having a complementary and/or supplemental profile to that of white tea. The green tea extract is preferably made by simple aqueous extraction in known manner. Note the above table in this connection, and that higher temperatures and longer steep times result in undesirable flavor formation. Note too, however, that it is preferable for the extract to be heat treated to deal with microbial loading, but flavor and solids concentration is preferably carried out through an evaporation process to prepare an appropriate concentrate. In these embodiments, the flavor balance should be adjusted so that white tea flavor (whether from white tea flavour or white tea flavor extracts or combinations thereof), clearly predominates and preferable completely masks the other extracts' flavor contribution.

In the diverse examples of the present invention presented hereinafter, a variety of ingredients have been variously employed.

Chicory syrup, (75% total solids), high fructose corn syrup (HFCS, about 77% total solids) and glucose-fructose syrup (42 FX from Cargil) have been incorporated to provide mouth feel and body, but also to provide sweetness for balancing out product bitterness and organic acidity. Chicory syrup is a high fructose syrup derived from enzymatically hydrolyzed inulin extracted from chicory root—and is generally less preferred in the practice of the present invention, as compared to the other two specifically mentioned sweetener syrups.

Lemon juice concentrate, citric acid, tannic acids (e.g. from tea extracts), are included to complement the acid sweetness balance mentioned above. In addition to its innate acid character, the lemon juice concentrate also provided a lemon flavor that is known to complement tea flavors.

A variety of malt-based beverages were used. Lagers from North America, Europe, Russia and Korea are included in these, along with a malt-based neutral alcoholic base. A de-alcoholized beer was also used in at least one example.

The white tea flavour (also known as white tea key) is a product commercially supplied by Firmenich in Switzerland, and in some examples (white tea combo), it is used in combination with a supplemental grapefruit/citrus flavour. The green tea liquid extract was commercially supplied by Halssen and Lyon in Germany. The freshness key is a commercially available product IFF in the Netherlands.

Caramel color was employed, as the reference might suggest, to provide color, especially in light colored lagers and malt-based alcoholic bases.

### EXAMPLE 1:

A non-alcoholic beer according to the present invention was prepared in accordance with the following:

| | |
|---|---|
| De-alcoholized beer | 53 |
| Water | 90.37 |
| Chicory syrup | 4.298 |
| Lemon Juice Concentrate | 0.325 |
| Green Tea Extract | 0.02 |
| White Tea Flavour | 0.02 |
| Total (%) | 100 |

### EXAMPLE 2:

A North American lager beer was employed in the production of:

Labatt Blue ™ lager beer

| Example 2a | 100 | 250 mL | 60 L | |
|---|---|---|---|---|
| Labatt Blue ™ (at 5% | 95.3875 | 238.47 | 57.33 | L |
| ethanol by volume) | | | | |
| Chicory syrup | 4.25 | 10.625 | 2.55 | Kg |
| Lemon Juice Conc. | 0.3125 | 0.78125 | 0.075 | Kg |
| Green tea extract | 0.02 | 0.05 | | |
| White Tea Key | 0.04 | 0.10 | 0.045 | L |
| | 100.01 | 250.025 | 60 | |

| | 100 | 4 L |
|---|---|---|
| Example 2b (6.6% | | |
| final ethanol | | |
| concentration by | | |
| volume.) | | |
| Labatt Blue ™ (at 7.85% | 80.734 | 3229.36 |
| alcohol by volume) | | |
| Water | 15.382 | 615.28 |
| Chicory syrup | 3.627 | 145.08 |
| Lemon Juice Conc. | 0.157 | 6.28 |
| green tea extract | 0.02 | 0.80 |
| White Tea Key only | 0.08 | 3.20 |
| | 100 | 4000 |
| Example 2c | | |
| Labatt Blue ™ (7.85% | 80.734 | 3229.36 |
| ABV) | | |
| Water | 15.322 | 612.88 |
| Chicory syrup | 3.627 | 145.08 |
| Lemon Juice Conc. | 0.157 | 6.28 |
| Citric Acid | 0.06 | 2.4 |
| green tea extract | 0.02 | 0.8 |
| White Tea Flavour | 0.08 | 3.2 |
| Freshness Key | 0.05 | 2 |
| | 100 | 4000 |

| Example 2d | | |
|---|---|---|
| (Blue ™ - 5.0% ABV) | 100 | 3 L |
| Labatt Blue ™ (7.85% | 61.18 | 2447.2 |
| ABV) | | |
| Water | 34.87 | 1394.8 |
| Chicory syrup | 3.627 | 145.08 |
| Lemon Juice Conc. | 0.157 | 6.28 |
| Citric Acid | 0.06 | 2.4 |
| green tea extract | 0.02 | 0.8 |
| White Tea flavour | 0.08 | 3.2 |
| Freshness Key | 0.05 | 2 |
| | 99.994 | 3999.76 |

| | % | bottle | |
|---|---|---|---|
| Example 2e | | | |
| Blue ™ | 96.25 | 341.00 | mL |
| Chicory syrup (75% TS) | 3.6 | 12.75 | g |
| Citric Acid | 0 | 0.00 | mL |
| Green Tea Extract | 0.02 | 0.07 | g |
| Freshness Key | 0.05 | 0.18 | mL |
| White tea flavour | 0.08 | 0.28 | mL |
| Total | 100 | 354.29 | mL |
| Example 2f | | | |
| Blue ™ | 96.2 | 341.00 | mL |
| Chicory syrup (75% TS) | 3.6 | 12.75 | g |
| Citric Acid | 0.05 | 0.18 | mL |
| Green Tea Extract | 0.02 | 0.07 | g |
| Freshness Key | 0.05 | 0.18 | mL |
| White tea flavour | 0.08 | 0.28 | mL |
| Total | 100 | 354.46 | mL |
| Example 2g | | | |
| Blue ™ | 96.15 | 341.00 | mL |
| Chicory syrup (75% TS) | 3.6 | 12.75 | g |
| Citric Acid | 0.10 | 0.35 | mL |
| Green Tea Extract | 0.02 | 0.07 | g |
| Freshness Key | 0.05 | 0.18 | mL |
| White tea flavour | 0.08 | 0.28 | mL |
| Total | 100 | 354.64 | mL |
| Example 2h | | | |
| Blue ™ | 96.1 | 341.00 | mL |
| Chicory syrup (75% TS) | 3.6 | 12.75 | g |
| Citric Acid | 0.15 | 0.53 | mL |
| Green Tea Extract | 0.02 | 0.07 | g |
| Freshness Key | 0.05 | 0.18 | mL |
| White tea flavour | 0.08 | 0.28 | mL |
| Total | 100 | 354.82 | mL |
| Example 2i | | | |
| Blue ™ | 96.175 | 341.00 | mL |
| Chicory syrup (75% TS) | 3.6 | 12.75 | g |
| Citric Acid | 0.075 | 0.27 | mL |
| Green Tea Extract | 0.02 | 0.07 | g |
| Freshness Key | 0.05 | 0.18 | mL |
| White tea flavour | 0.08 | 0.28 | mL |
| Total | 100 | 354.55 | mL |
| Example 2j | | | |
| Blue ™ | 96.6 | 341.00 | mL |
| Chicory syrup (75% TS) | 3.2 | 11.34 | g |
| Citric Acid | 0.05 | 0.18 | g |
| Green Tea Extract | 0.02 | 0.07 | g |
| Freshness Key | 0.05 | 0.18 | mL |
| White tea flavour | 0.08 | 0.28 | mL |
| Total | 100 | 353.05 | mL |

| Example 2k | % | 6 L |
|---|---|---|
| Blue ™ @7.74% ABV | 64.6 | 3876 |
| Chicory syrup | 3.2 | 192 |
| Citric Acid | 0.05 | 3 |
| Green Tea Extract | 0.02 | 1.2 |
| Freshness Key | 0.05 | 3 |
| White tea flavour | 0.08 | 4.8 |
| Water | 32 | 1920 |
| Total | 100 | 6000 |

### EXAMPLE 3:

This example relates to the production of an embodiment of the present invention based on a more flavor neutral malt-based alcoholic beverage.

Neutral Malt Base (3.0% alcohol by volume)

| Prototype #1 | | | | 4 L |
|---|---|---|---|---|
| Neutral Base | 50 | | 165 | 2000 |
| Water | 43.725 | | 144.2925 | 1749 |
| Chicory syrup | 5.85 | G | 19.305 | 234 |
| Citric Acid | | | 0 | |
| Lemon Juice Concentrate | 0.365 | ML | 1.2045 | 14.6 |
| Green Tea Extract | 0.02 | | 0.066 | 0.8 |
| Caramel Colour | | | 0 | |
| Flavour WT | 0.04 | | 0.132 | 1.6 |
| | 100 | | 330 | 4000 |
| Prototype #2 - 3% | | | | 3 L |
| Neutral Base | 50 | | 165 | 1500 |
| Water | 44.075 | | 145.4475 | 1322.25 |
| Chicory syrup | 5.5 | G | 18.15 | 165 |
| Citric Acid | | | 0 | 0 |
| Lemon Juice Concentrate | 0.365 | ML | 1.2045 | 10.95 |
| Green Tea Extract | 0.02 | | 0.066 | 0.6 |
| Caramel Colour | | | 0 | 0 |
| Flavour WT combo | 0.04 | | 0.132 | 1.2 |
| | 100 | | 330 | 3000 |
| Prototype #3 - 3% | | | | 4 L |
| Neutral Base | 50 | | 165 | 2000 |
| Water | 43.749 | | 144.3717 | 1749.96 |
| Chicory syrup | 5.85 | G | 19.305 | 234 |
| Citric Acid | 0.016 | | 0.0528 | 0.64 |
| Lemon Juice Concentrate | 0.325 | ML | 1.0725 | 13 |
| Green Tea Extract | 0.02 | | 0.066 | 0.8 |
| Caramel Colour | | | 0 | |
| Flavour WT | 0.04 | | 0.132 | 1.6 |
| | 100 | | 330 | 4000 |

| | | | | 3 L |
|---|---|---|---|---|
| Prototype #4 - 5% | | | | |
| Neutral Base (9.17% ABV) | 50 | | 165 | 1500 |
| Water | 44.075 | | 145.4475 | 1322.25 |
| Chicory syrup | 5.5 | G | 18.15 | 165 |
| Citric Acid | | | 0 | 0 |
| Lemon Juice Concentrate | 0.365 | ML | 1.2045 | 10.95 |
| Green Tea Extract | 0.02 | | 0.066 | 0.6 |
| Caramel Colour | | | 0 | 0 |
| Flavour WT combo | 18 0.04 | | 0.132 | 1.2 |
| | 100 | | 330 | 3000 |
| Prototype #5 - 5% ABV | | | | |
| Neutral Base (9.17% ABV) | 50 | | 165 | 1500 |
| Water | 44.075 | | 145.4475 | 1322.25 |
| Chicory syrup | 5.5 | G | 18.15 | 165 |
| Citric Acid | | | 0 | 0 |
| Lemon Juice Concentrate | 0.365 | ML | 1.2045 | 10.95 |
| Green Tea Extract | 0.02 | | 0.066 | 0.6 |
| Caramel Colour | | | 0 | 0 |
| Flavour WT combo | 0.04 | | 0.132 | 1.2 |
| | 100 | | 330 | 3000 |

Low Carbohydrate Beer

| | % | bottle | |
|---|---|---|---|
| Formula #1 | | | |
| Sterling ™ | 99.7227 | 341.00 | mL |
| Chicory syrup (75% TS) | 0.05865 | 0.20 | mL |
| Citric Acid (50% wt/wt) | 0.05865 | 0.20 | mL |
| White tea key | 0.16 | 0.55 | mL |
| Total | 100 | 341.95 | mL |
| Formula #2 | | | |
| Sterling ™ | 98.5 | 341.00 | mL |
| Chicory syrup (75% TS) | 1.28 | 4.43 | mL |
| Citric Acid (50% wt/wt) | 0.06 | 0.21 | mL |
| White tea key | 0.16 | 0.55 | mL |
| Total | 100 | 346.14 | mL |
| Formula #3 | | | |
| Sterling ™ | 98.42 | 341.00 | mL |
| Chicory syrup (75% TS) | 1.28 | 4.43 | mL |
| Citric Acid (50% wt/wt) | 0.1 | 0.35 | mL |
| White tea key | 0.2 | 0.69 | mL |
| Total | 100 | 346.41 | mL |
| Formula #4 | | | |
| Sterling ™ | 98.42 | 341.00 | mL |
| Chicory syrup (75% TS) | 1.28 | 4.43 | mL |
| Citric Acid (50% wt/wt) | 0.08 | 0.28 | mL |
| White tea key | 0.22 | 0.76 | mL |
| Total | 100 | 346.41 | mL |

Beck's Gold ™ beer

| | | | |
|---|---|---|---|
| Becks Gold ™ | 96.7 | 341.00 | mL |
| HFCS 55 (77% TS) | 3.12 | 11.00 | g |
| Citric Acid | 0.05 | 0.18 | g |
| Freshness Key | 0.05 | 0.18 | mL |
| White tea flavour | 0.08 | 0.28 | mL |
| Total | 100 | 352.64 | mL |
| Becks Gold ™ | 96.68 | 341.00 | mL |
| HFCS 55 (77% TS) | 3.12 | 11.00 | g |
| Citric Acid | 0.05 | 0.18 | g |
| Freshness Key | 0.07 | 0.25 | mL |
| White tea flavour | 0.08 | 0.28 | mL |
| Total | 100 | 352.71 | mL |
| Becks Gold ™ | 96.295 | 341.00 | mL |
| HFCS 55 (77% TS) | 3.5 | 12.39 | g |
| Citric Acid | 0.075 | 0.27 | mL |
| Freshness Key | 0.05 | 0.18 | mL |
| White tea flavour | 0.08 | 0.28 | mL |
| Total | 100 | 354.12 | mL |
| Becks Gold ™ | 96.27 | 341.00 | mL |
| HFCS 55 (77% TS) | 3.5 | 12.40 | g |
| Citric Acid | 0.10 | 0.35 | mL |
| Freshness Key | 0.05 | 0.18 | mL |
| White tea flavour | 0.08 | 0.28 | mL |
| Total | 100 | 354.21 | mL |

Beck's Gold ™

| | | | |
|---|---|---|---|
| Becks Gold ™ | 96.27 | 341.00 | mL |
| HFCS 55 (77% TS) | 3.5 | 12.40 | g |
| Citric Acid | 0.10 | 0.35 | mL |
| Freshness Key | 0.05 | 0.18 | mL |
| White tea flavour | 0.08 | 0.28 | mL |
| Total | 100 | 354.21 | mL |
| Becks Gold ™ | 96.25 | 341.00 | mL |
| HFCS 55 (77% TS) | 3.5 | 12.40 | g |
| Citric Acid | 0.10 | 0.35 | mL |
| Freshness Key | 0.07 | 0.25 | mL |
| White tea flavour | 0.08 | 0.28 | mL |
| Total | 100 | 354.29 | mL |
| Becks Gold ™ | 96.25 | 341.00 | mL |
| HFCS 55 (77% TS) | 3.5 | 12.40 | g |
| Citric Acid | 0.10 | 0.35 | mL |
| Freshness Key | 0.05 | 0.18 | mL |
| White tea flavour | 0.1 | 0.35 | mL |
| Total | 100 | 354.29 | mL |
| Becks Gold ™ | 95.97 | 341.00 | mL |
| HFCS 55 (77% TS) | 3.8 | 13.50 | g |
| Citric Acid | 0.10 | 0.36 | mL |
| Freshness Key | 0.05 | 0.18 | mL |
| White tea flavour | 0.08 | 0.28 | mL |
| Total | 100 | 355.32 | mL |

BECK'S GOLD ™

| | | | |
|---|---|---|---|
| Becks Gold ™ | 95.97 | 341.00 | mL |
| HFCS 55 (77% TS) | 3.8 | 13.50 | g |
| Citric Acid | 0.10 | 0.36 | mL |
| Freshness Key | 0.05 | 0.18 | mL |
| White tea flavour | 0.08 | 0.28 | mL |
| Total | 100 | 355.32 | mL |
| Becks Gold ™ | 96.25 | 341.00 | mL |
| HFCS 55 (77% TS) | 3.5 | 12.40 | g |
| Citric Acid | 0.100 | 0.35 | mL |
| Freshness Key | 0.05 | 0.18 | mL |
| White tea flavour | 0.1 | 0.35 | mL |
| Total | 100 | 354.29 | mL |
| Becks Gold ™ | 96.68 | 341.00 | mL |
| HFCS 55 (77% TS) | 3.12 | 11.00 | g |
| Citric Acid | 0.05 | 0.18 | g |
| Freshness Key | 0.07 | 0.25 | mL |
| White tea flavour | 0.08 | 0.28 | mL |
| Total | 100 | 352.71 | mL |
| Becks Gold ™ | 95.99 | 341.00 | mL |
| HFCS 55 (77% TS) | 3.8 | 13.50 | g |
| Citric Acid | 0.10 | 0.36 | mL |
| Freshness Key | 0.05 | 0.18 | mL |
| White tea flavour | 0.06 | 0.21 | mL |
| Total | 100 | 355.25 | mL |

Blue ™

| | | | |
|---|---|---|---|
| Blue ™ | 96.62 | 341.00 | mL |
| Chicory syrup (75% TS) | 3.2 | 11.29 | g |
| Citric Acid | 0.05 | 0.18 | g |
| Freshness Key | 0.05 | 0.18 | mL |
| White tea flavour | 0.08 | 0.28 | mL |
| Total | 100 | 352.93 | mL |
| Blue ™ | 96.6 | 341.00 | mL |
| Chicory syrup (75% TS) | 3.2 | 11.30 | g |
| Citric Acid | 0.05 | 0.18 | g |
| Green Tea Extract | 0.02 | 0.07 | g |
| Freshness Key | 0.05 | 0.18 | mL |
| White tea flavour | 0.08 | 0.28 | mL |
| Total | 100 | 353.00 | mL |
| Blue ™ | 96.7 | 341.00 | mL |
| HFCS 55 (77% TS) | 3.12 | 11.00 | g |
| Citric Acid | 0.05 | 0.18 | g |
| Freshness Key | 0.05 | 0.18 | mL |
| White tea flavour | 0.08 | 0.28 | mL |
| Total | 100 | 352.64 | mL |
| Blue ™ | 96.68 | 341.00 | mL |
| HFCS 55 (77% TS) | 3.12 | 11.00 | g |
| Citric Acid | 0.05 | 0.18 | g |
| Freshness Key | 0.07 | 0.25 | mL |
| White tea flavour | 0.08 | 0.28 | mL |
| Total | 100 | 352.71 | mL |
| Blue ™ | 96.295 | 341.00 | mL |
| HFCS 55 (77% TS) | 3.5 | 12.39 | g |
| Citric Acid | 0.075 | 0.27 | mL |
| Freshness Key | 0.05 | 0.18 | mL |
| White tea flavour | 0.08 | 0.28 | mL |
| Total | 100 | 354.12 | mL |
| Blue ™ | 96.27 | 341.00 | mL |
| HFCS 55 (77% TS) | 3.5 | 12.40 | g |
| Citric Acid | 0.10 | 0.35 | mL |
| Freshness Key | 0.05 | 0.18 | mL |
| White tea flavour | 0.08 | 0.28 | mL |
| Total | 100 | 354.21 | mL |

Klinskoe Svetloe ™

| | | | |
|---|---|---|---|
| Klinskoe Svetloe ™ | 96.27 | 341.00 | mL |
| HFCS 55 (77% TS) | 3.5 | 12.40 | g |
| Citric Acid | 0.10 | 0.35 | mL |
| Freshness Key | 0.05 | 0.18 | mL |
| White tea flavour | 0.08 | 0.28 | mL |
| Total | 100 | 354.21 | mL |
| Klinskoe Svetloe ™ | 96.7 | 341.00 | mL |
| HFCS 55 (77% TS) | 3.12 | 11.00 | g |
| Citric Acid | 0.05 | 0.18 | g |
| Freshness Key | 0.05 | 0.18 | mL |
| White tea flavour | 0.08 | 0.28 | mL |
| Total | 100 | 352.64 | mL |
| Klinskoe Svetloe ™ | 96.68 | 341.00 | mL |
| HFCS 55 (77% TS) | 3.12 | 11.00 | g |
| Citric Acid | 0.05 | 0.18 | g |
| Freshness Key | 0.05 | 0.18 | mL |
| White tea flavor | 0.1 | 0.35 | mL |
| Total | 100 | 352.71 | mL |

Samurai ™

| | | | |
|---|---|---|---|
| Klinskoe Samurai ™ | 96.295 | 500.00 | mL |
| HFCS 55 (77% TS) | 3.5 | 18.17 | g |
| Citric Acid | 0.075 | 0.39 | g |
| Freshness Key | 0.05 | 0.26 | mL |
| White tea flavor | 0.08 | 0.42 | mL |
| Total | 100 | 519.24 | mL |
| Klinskoe Samurai ™ | 96.61 | 480.00 | mL |
| HFCS 55 (77% TS) | 3.2 | 15.90 | g |
| Citric Acid | 0.060 | 0.30 | g |
| Freshness Key | 0.05 | 0.25 | L |
| White tea flavour | 0.08 | 0.40 | L |
| Total | 100 | 496.84 | L |

Arriva ™

| | | | |
|---|---|---|---|
| Arriva ™ | 96.262 | 300.00 | mL |
| HFCS 55 (77% TS) | 3.5 | 10.91 | g |
| Citric Acid | 0.075 | 0.23 | g |
| Freshness Key | 0.05 | 0.16 | mL |
| White tea flavour | 0.08 | 0.25 | mL |
| Liquid Green Tea Extract | 0.033 | 0.10 | mL |
| Total | 100 | 311.65 | mL |
| Arriva ™ | 96.577 | 480.00 | mL |
| HFCS 55 (77% TS) | 3.2 | 15.90 | g |
| Citric Acid | 0.060 | 0.30 | g |
| Freshness Key | 0.05 | 0.25 | ml |
| White tea flavour | 0.08 | 0.40 | ml |
| Liquid Green Tea Extract | 0.033 | 0.16 | ml |
| Total | 100 | 496.85 | ml |
| Arriva ™ | 96.692 | 330.00 | mL |
| HFCS 55 (77% TS) | 3.1 | 10.58 | g |
| Citric Acid | 0.045 | 0.15 | g |
| Freshness Key | 0.05 | 0.17 | ml |
| White tea flavour | 0.08 | 0.27 | ml |
| Liquid Green Tea Extract | 0.033 | 0.11 | ml |
| Total | 100 | 341.18 | ml |
| Arriva ™ | 95.912 | 300.00 | mL |
| Glucose fructose 42Fx | 3.85 | 12.00 | g |
| Citric Acid | 0.075 | 0.23 | g |
| Freshness Key | 0.05 | 0.16 | mL |
| White tea flavour | 0.08 | 0.25 | mL |
| Liquid Green Tea Extract | 0.033 | 0.10 | ml |
| Total | 100 | 312.64 | mL |
| Arriva ™ | 97.157 | 480.00 | mL |
| Glucose Fructose 42FX | 2.62 | 12.94 | ml |
| Citric Acid | 0.060 | 0.30 | g |
| Freshness Key | 0.05 | 0.25 | ml |
| White tea flavour | 0.08 | 0.40 | ml |
| Liquid Green Tea Extract | 0.033 | 0.16 | ml |
| Total | 100 | 493.88 | ml |
| Arriva ™ | 97.177 | 150.00 | mL |
| Glucose Fructose 42Fx | 2.62 | 4.04 | ml |
| Citric Acid | 0.060 | 0.09 | g |
| Freshness Key | 0.05 | 0.08 | ml |
| White tea flavour | 0.06 | 0.09 | ml |
| Liquid Green Tea Extract | 0.033 | 0.05 | ml |
| Total | 100 | 154.31 | ml |
| Arriva ™ | 97.192 | 150.00 | mL |
| Glucose Fructose 42Fx | 2.62 | 4.04 | ml |
| Citric Acid | 0.060 | 0.09 | g |
| Freshness Key | 0.035 | 0.05 | ml |
| White tea flavour | 0.06 | 0.09 | ml |
| Liquid Green Tea Extract | 0.033 | 0.05 | ml |
| Total | 100 | 154.33 | ml |
| Arriva ™ | 97.212 | 150.00 | mL |
| Glucose Fructose 42Fx | 2.62 | 4.04 | ml |
| Citric Acid | 0.040 | 0.06 | g |
| Freshness Key | 0.035 | 0.05 | ml |
| White tea flavour | 0.06 | 0.09 | ml |
| Liquid Green Tea Extract | 0.033 | 0.05 | ml |
| Total | 100 | 154.25 | ml |

OB Lager ™

| | | | |
|---|---|---|---|
| OB Lager ™ | | 341.00 | mL |
| HFCS 55 (77% TS) | 3.12 | 11.00 | g |
| Citric Acid | 0.05 | 0.18 | g |
| Freshness Key | 0.05 | 0.18 | mL |
| White tea flavour | 0.08 | 0.28 | mL |
| Total | 100 | 352.64 | mL |
| OB Lager ™ | 97.33 | 341.00 | mL |
| HFCS 55 (77% TS) | 2.5 | 8.82 | g |
| Citric Acid | 0.04 | 0.14 | g |
| Freshness Key | 0.05 | 0.18 | mL |
| White tea flavour | 0.08 | 0.28 | mL |
| Total | 100 | 350.42 | mL |
| OB Lager ™ | 97.33 | 341.00 | mL |
| HFCS 55 (77% TS) | 2.5 | 8.76 | g |
| Citric Acid | 0.04 | 0.14 | g |
| Freshness Key | 0.05 | 0.18 | mL |
| White tea flavour | 0.08 | 0.28 | mL |
| Total | 100 | 350.35 | mL |
| OB Lager ™ | 97.33 | 341.00 | mL |
| HFCS 55 (77% TS) | 2.9 | 10.16 | g |
| Citric Acid | 0.04 | 0.14 | g |
| Freshness Key | 0.05 | 0.18 | mL |
| White tea flavour | 0.08 | 0.28 | mL |
| Total | 100.4 | 351.76 | mL |

Brahma ™

| | | | |
|---|---|---|---|
| Brahma ™ ™ | 97.33 | 341.00 | mL |
| HFCS 55 (77% TS) | 2.5 | 8.76 | g |
| Citric Acid | 0.04 | 0.14 | g |
| Freshness Key | 0.05 | 0.18 | mL |
| White tea flavour | 0.08 | 0.28 | mL |
| Total | 100 | 350.35 | mL |
| Brahma ™ | 96.7 | 341.00 | mL |
| HFCS 55 (77% TS) | 3.12 | 11.00 | g |
| Citric Acid | 0.05 | 0.18 | g |
| Freshness Key | 0.05 | 0.18 | mL |
| White tea flavour | 0.08 | 0.28 | mL |
| Total | 100 | 352.64 | mL |
| Brahma ™ | 96.295 | 341.00 | mL |
| HFCS 55 (77% TS) | 3.5 | 12.39 | g |
| Citric Acid | 0.075 | 0.27 | g |
| Freshness Key | 0.05 | 0.18 | mL |
| White tea flavour | 0.08 | 0.28 | mL |
| Total | 100 | 354.12 | mL |

| | |
|---|---|
| Ingredient | Quantity |

Trial 1:

| | |
|---|---|
| Klinskoe Arriva ™ [hl] | 97.19 |
| Glucose - Fructose - | 2.62 |
| Syrup [hl] | |
| Citric Acid [kg] | 6.0 |
| Freshness Key [hl] | 0.05 |
| White Tea Flavour [hl] | 0.08 |
| Green Tea Extract [hl] | 0.033 |

Trial 2:

| | |
|---|---|
| Klinskoe Arriva ™ [hl] | 97.25 |
| Glucose - Fructose - | 2.62 |
| Syrup [hl] | |
| Citric Acid [kg] | 4.0 |
| Freshness Key [hl] | 0.035 |
| White Tea Flavour [hl] | 0.06 |
| Green Tea Extract [hl] | 0.033 |

Trial 3:

| | |
|---|---|
| Klinskoe Arriva ™ [hl] | 97.25 |
| Glucose - Fructose - | 2.096 |
| Syrup [hl] | |
| Citric Acid [kg] | 3.2 |
| Freshness Key [hl] | 0.028 |
| White Tea Flavour [hl] | 0.048 |
| Green Tea Extract [hl] | 0.0264 |

1. A white tea flavored malt-based beverage.

2. The malt-based beverage according to claim 1, wherein said beverage is a beer.

3. The malt-based beverage according to claim 1, wherein said beverage is a neutral malt-based alcoholic beverage.

4. The malt-based beverage according to claim 1, wherein said beverage is a de-alcoholized beer.

5. The malt-based beverage according to claim 1, wherein said beverage is a low carbohydrate beer.

6. The beer according to claim 1 wherein said beer comprises one or more of the group consisting of: white tea flavor; and/or white tea flavor extract.

7. The beer according to claim 6 wherein said beer comprises a white tea flavor extract.

8. The beer according to claim 7 wherein said white tea flavor extract includes monomeric catechins.

9. The beer according to claim 8 wherein said monomeric catechins include one or more of the group consisting of: epicatechin, epigallocatechin, epicatechin gallate, and/or epigallocatechin gallate.

10. The beer according to claim 8 wherein said extract further includes one or more of the group consisting of: fluoride, caffeine, and/or flavonols.

11. The beer according to claim 10, wherein said flavonoids are selected from the group consisting of kaempferol, quercetin, and/or myricitin.

12. The beer according to claim 7 wherein said extract is added following beer filtration.
